(19) United States
(12) Patent Application Publication
(10) Pub. No.: US 2016/0223019 A1
(43) Pub. Date: Aug. 4, 2016

(54) CAGE, ROLLING BEARING AND PUMP FOR LIQUEFIED GAS

(71) Applicant: NSK LTD., Tokyo (JP)

(72) Inventors: Toyohisa Yamamoto, Fujisawa-shi, Kanagawa (JP); Masachi Hosoya, Fujisawa-shi, Kanagawa (JP)

(73) Assignee: NSK LTD., Tokyo (JP)

(21) Appl. No.: 15/025,926

(22) PCT Filed: Oct. 8, 2014
(86) PCT No.: PCT/JP2014/077014

§ 371 Date: Mar. 30, 2016

(30) Foreign Application Priority Data
Oct. 9, 2013 (JP) 2013-212029

(51) Int. Cl. F16C 33/62; C10M 103/06; F16C 19/06; C10M 103/02; F16C 33/66; F16C 33/44

(52) U.S. Cl. CPC F16C 33/62; F16C 33/6696; F16C 33/44; F16C 19/06; C10M 103/02; C10M 103/06

(57) ABSTRACT

There is provided a rolling bearing used in a liquefied gas environment or in an extremely low temperature, wherein an inner ring and an outer ring are made of steel material which is any one of bearing steel, stainless steel, high-speed tool steel and cemented steel, and a rolling element of the rolling bearing is made of ceramic having a coefficient of linear expansion of 70% to 105% of a coefficient of linear expansion of the steel material forming the inner ring and outer ring. A liquefied gas pump including the rolling bearing is also provided. Further, there is provided a cage which contains PTFE, a fibrous reinforcing material and a solid lubricant, and which is suitable for the above rolling bearing or the like.

### TECHNICAL FIELD

The present invention relates to a rolling bearing to be used in an extremely low temperature environment for a pump for liquefied gas configured to pneumatically transport a liquefied gas such as liquid nitrogen, liquid oxygen, liquid natural gas and the like. Also, the present invention relates to a cage suitable for the rolling bearing.

### BACKGROUND ART

A pump (pump for liquefied gas) configured to pneumatically transport a liquefied gas has a rolling bearing such as a deep groove ball bearing and a cylindrical roller bearing so as to support a main shaft to which an impeller configured to pneumatically transport the liquefied gas is attached. Since the rolling bearing is in contact with the liquefied gas, a steel material configuring the bearing may be corroded and deteriorated by the liquefied gas. In view of this, there has been known a configuration where an outer ring, an inner ring and a rolling element are all formed of martensitic stainless steel (SUS 440C and the like) having corrosion resistance or the rolling element is formed of high-speed tool steel (AISI M50) (for example, refer to Patent Document 1).

When the inner/outer rings and the rolling element are all made of the metal material, the wear increases due to metallic contact. Therefore, the rolling element may be made of ceramic (for example, refer to Patent Document 2). When the rolling element is made of ceramic, the electrolytic corrosion can also be prevented, so that the bearing lifetime is prolonged.

Also, since the rolling bearing is used in extremely low temperatures, the lubricant such as lubricant oil and grease cannot be arranged in the bearing for lubricating the rolling bearing. Therefore, the rolling bearing is rotated in a non-lubrication environment, so that the lifetime thereof may be lowered due to the wear. In view of this, a cage including a solid lubrication film having a low coefficient of friction (for example, refer to Patent Document 3) or a cage made of a resin composition containing a solid lubricant (for example, refer to Patent Document 4) is incorporated to provide wear resistance in the non-lubrication environment.

### BACKGROUND ART DOCUMENT

### Patent Document

Patent Document 1: JP-A-S63-69818

Patent Document 2: JP-A-2007-127277

Patent Document 3: JP-A-2006-220240

Patent Document 4: JP-A-2002-213455

### SUMMARY OF THE INVENTION

### Problems to be Solved

However, regarding the boiling point (1 atm) of the liquefied gas, the liquid nitrogen is about −196° C., the liquid oxygen is about −183° C., the liquefied methane gas is about −164° C., and the liquefied butane gas is about +1° C. In this wide temperature range, as the temperature decreases, an amount of change in a bearing internal clearance increases in the rolling bearing which is to be used in the low temperature environment (1° C. or lower), particularly, the extremely low temperature environment (−30° C. or lower), such as the rolling bearing of which the inner/outer rings are made of the steel material and the rolling element is made of the ceramic (Patent Document 2). As the bearing internal clearance increases, the vibrations also increase and the wear is more likely to occur.

Further, since the rolling bearing is used in the non-lubrication environment, it is needed to further improve the wear resistance even in the cage for which the wear resistance is provided by the lubrication film or the solid lubricant as disclosed in Patent Documents 3 and 4.

It is therefore an object of the present invention to provide a long lifespan rolling bearing exhibiting an excellent lubricating property and having improved wear resistance even when it is used in a low temperature environment (1° C. or lower), particularly, an extremely low temperature environment (−30° C. or lower), and in a non-lubrication environment. Another object of the present invention is to provide a cage which is suitable for the rolling bearing. A further object of the present invention is to provide a long lifespan pump for liquefied gas having the rolling bearing.

### Means for Solving the Problem

In order to achieve the above objects, according to the present invention, the following cage, rolling bearing and pump for liquefied gas are provided.

(1) A rolling bearing having a plurality of rolling elements held between an inner ring and an outer ring via a cage and to be used in a liquefied gas environment or in an extremely low temperature, wherein the inner ring and the outer ring are made of steel material which is any one of bearing steel, stainless steel, high-speed tool steel and cemented steel, and wherein the rolling elements are made of ceramic having a coefficient of linear expansion of 70% to 105% of a coefficient of linear expansion of the steel material forming the inner ring and the outer ring.

(2) In the rolling bearing of (1), the cage is made of a resin composition.

(3) In the rolling bearing of (1) or (2), a bearing accuracy is Normal class or higher of ISO492 standard.

(4) In the rolling bearing of any one of (1) to (3), the steel material forming the inner ring and the outer ring is subjected to sub-zero treatment.

(5) In the rolling bearing of any one of (1) to (4), hardness of the ceramic forming the rolling element is Hv 1000 to Hv 1500.

(6) In the rolling bearing of (2), a resin component of the resin composition forming the cage is at least one of PTFE, polyamide, PEEK and PPS.

(7) In the rolling bearing of (6), the resin composition forming the cage contains, as a fibrous filler, at least one of a glass fiber, a carbon fiber, a calcium titanate whisker and an aluminum borate whisker.

(8) In the rolling bearing of (7), the resin composition forming the cage contains, as a solid lubricant, at least one of graphite, MoS₂ and WS₂.

(9) In the rolling bearing of (8), the resin composition forming the cage contains the glass fiber of 10 to 20 mass %, MoS₂ of 4.5 to 5.5 mass % and a remnant of PTFE.

(10) In the rolling bearing of any one of (1) to (9), the rolling element includes an alumina component and a zirconia component in a mass ratio between alumina component:zirconia component=5:95 to 50:50.

(11) In the rolling bearing of any one of (1) to (10), the cage is configured by split cages divided in two in a circumferential direction, and the split cages are fastened by a rivet to be integral.

(12) In the rolling bearing of (11), a washer is inserted between a rivet head of the rivet and the split cages.

(13) A pump for liquefied gas including the rolling bearing of any one of (1) to (12).

(14) A cage to be incorporated into a rolling bearing which is to be used in a liquefied gas environment or in an extremely low temperature, the cage being made of a resin composition containing:

a resin which is at least one of PTFE, polyamide, PEEK and PPS,

a fibrous filler which is at least one of a glass fiber, a carbon fiber, an calcium titanate whisker and an aluminum borate whisker, and

a resin which is at least one of PTFE, polyamide, PEEK and PPS.

(15) In the cage of (14), the resin composition contains the glass fiber of 10 to 20 mass %, MoS₂ of 4.5 to 5.5 mass %, and a remnant of PTFE.

(16) In the cage of (14) or (15), the cage is configured by split cages divided in two in a circumferential direction, and the split cages are fastened by a rivet to be integral.

(17) In the cage of (16), a washer is inserted between a rivet head of the rivet and the split cages.

### Effects of the Invention

According to the rolling bearing of the present invention, the inner and outer rings are made of the specific steel material, the rolling element is made of the ceramic, and a ratio of the coefficients of linear expansion thereof is set within the specific range, so that it is possible to cope with various liquefied gases having different temperatures. Also, when handling the liquefied gas of low temperatures, a change in a bearing internal clearance is small and the vibrations are reduced, as compared to the background-art rolling bearing having the rolling element made of the ceramic, so that the wear resistance is improved. Also, since the cage of the present invention is reinforced by the fibrous filler and is provided with the lubricating property by the solid lubricant, the cage exhibits the sufficient lubricating lifetime even in the non-lubrication environment where the lubricant oil or the grease is not used. Further, the pump for liquefied gas of the present invention has the longer lifetime since it has the above rolling bearing.

### BRIEF DESCRIPTION OF DRAWINGS

FIG. 1 is a sectional view showing a deep groove ball bearing which is an example of the rolling bearing of the present invention.

FIG. 2 is a sectional view showing an angular ball bearing which is another example of the rolling bearing of the present invention.

FIG. 3 is a graph showing a calculation result of a radial internal clearance depending on temperatures for a rolling bearing having inner/outer rings made of SUS440C and a ball made of silicon nitride or a ball made of alumina-zirconia according to the present invention.

FIG. 4 is a sectional view showing a submerged pump for liquefied gas, which is an example of the pump for liquefied gas of the present invention.

FIG. 5 is a sectional view showing a slide friction/wear test apparatus used in an example.

FIG. 6 is an enlarged sectional view showing a vicinity of the test apparatus shown in FIG. 5.

FIG. 7 is a sectional view showing a bearing test apparatus used in an example.

FIG. 8 is a sectional view showing a rivet-fastened ability evaluation test apparatus used in an example.

FIG. 9 shows a closed state of a pressing die in the test apparatus shown in FIG. 8.

FIG. 10 is a graph showing a verification result of glass fiber content.

FIG. 11 is a graph showing a result of verification 1 of MoS₂ content.

FIG. 12 is a graph showing a result of verification 2 of MoS₂ content.

FIG. 13 is a graph showing a comparison result of durability performance of a rolling bearing having a cage containing glass fibers and MoS₂ and a rolling bearing having a cage containing glass fibers without MoS₂.

FIG. 14 is a graph showing a comparison result of durability performance depending on ball materials.

FIG. 15 is a graph showing a change in a rivet recess depth in a rivet fastening ability evaluation 1.

FIG. 16 is a graph showing a relation between a pressure receiving area ratio and a rivet recess depth ratio in the rivet fastening ability evaluation 1.

FIG. 17 is a graph showing a result of a rivet fastening ability evaluation 2.

### DETAILED DESCRIPTION OF EMBODIMENTS

Hereinafter, the present invention will be described in detail with reference to the drawings.

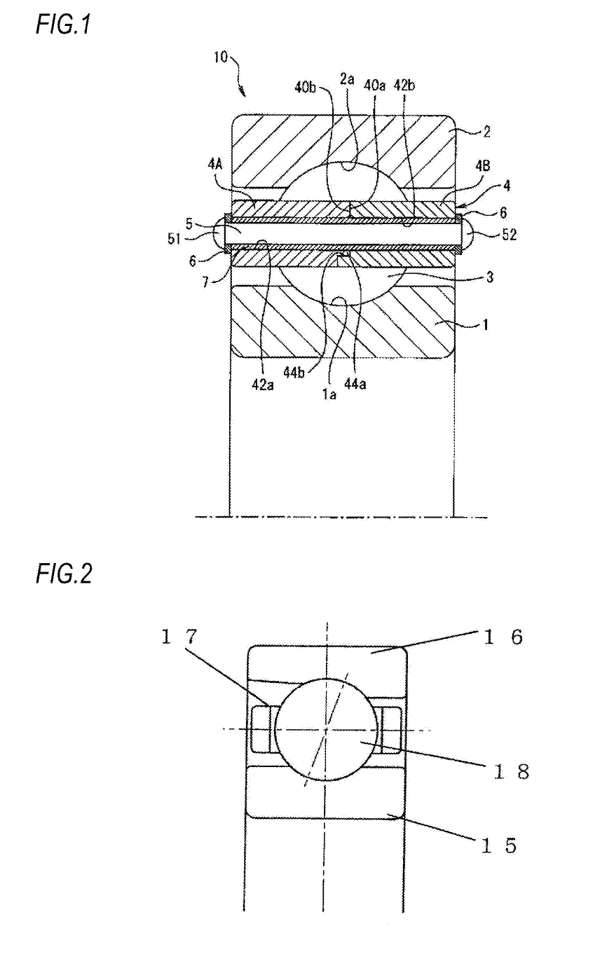

In the present invention, a type of a rolling bearing is not limited. The present invention is applied to a rolling bearing to be incorporated into an apparatus such as a pump for liquefied gas which is to be used in an extremely low temperature environment. For example, a deep groove ball bearing 10 shown in FIG. 1 can be exemplified. The shown deep groove ball bearing 10 has a configuration where a ball 3, which is a rolling element, is held to roll freely between an inner ring 1 and an outer ring 2 by a cage 4.

The cage 4 may be divided in two in a circumferential direction thereof. In this case, the two split cages are coupled by a spring pin 7 and are fastened by crimping a rivet 5. Specifically, as shown, a pair of annular components 4A, 4B divided in two in a circumferential direction is arranged concentrically with the inner ring 1 and the outer ring 2, and is also arranged to face each other with sandwiching the ball 3 from both axial sides. Axial end surfaces of both annular components 4A, 4B configured to sandwich the ball 3 therebetween face each other, and the facing surfaces are respectively formed with a plurality of spherically-concave portions at an equal interval and in a line in the circumferential direction. The numbers of the spherically-concave portions formed on both facing surfaces are the same and the spherically-concave portions are arranged to face each other. Therefore, a circular pocket penetrating the cage 4 in a diametrical direction is configured by the two facing spherically-concave portions, and the ball 3 is held in each pocket.

Portions 40a, 40b (hereinafter, referred to as ‘abutting surfaces 40a, 40b’) of both annular components 4A, 4B, at which the spherically-concave portions are not formed, are abutted to each other, so that columns of the cage 4 are configured. That is, the columns are respectively formed between the pocket and the pocket and are arranged at an equal interval in the circumferential direction. Portions (column portions) at which the facing surfaces of both annular components 4A, 4B are abutted are respectively provided with through-holes 42a, 42b axially extending.

Both annular components 4A, 4B have a spigot joint structure. That is, one (in the example of FIG. 1, the abutting surface 40a of the annular component 4A) of the abutting surfaces 40a, 40b of both annular components 4A, 4B is formed with a spigot convex portion 44a, and the other (in the example of FIG. 1, the abutting surface 40b of the annular component 4B) is formed with a spigot concave portion 44b to be engaged with the spigot convex portion 44a. When the spigot convex portion 44a is fitted into the spigot concave portion 44b, inner peripheral surfaces and outer peripheral surfaces of both annular components 4A, 4B are positioned, so that no step occurs at the coupling parts of both annular components 4A, 4B, and the facing through-holes 42a, 42b are positioned, so that opening positions of both through-holes 42a, 42b coincide with each other.

Since the opening positions of the facing through-holes 42a, 42b coincide with each other, both through-holes 42a, 42b linearly continue and a linear hole is thus formed from both continuing through-holes 42a, 42b. In the linear hole, the rivet 5 is inserted over both ends of the linear hole, so that both annular components 4A, 4B are coupled and integrated. In the meantime, the rivet 5 may be inserted into all of the linear holes formed in the plurality of columns or may be inserted into some of the linear holes, respectively. The spigot convex portion 44a and the spigot concave portion 44b may be provided for all the columns or may be provided for some (one or more) of the columns.

Both annular components 4A, 4B are coupled by the rivet 5. When the rivet 5 is inserted into the through-hole 42a of the annular component 4A from an opening of an axial end surface (a left side in FIG. 1) of the cage 4, an end portion of the rivet at which a rivet head 51 is not formed protrudes from an opening of an axial end surface (a right side in FIG. 1) of the through-holes 42b of the annular components 4B. Therefore, both annular components 4A, 4B can be coupled by crimping the protruding end portion. In the example of FIG. 1, a semispherical crimping rivet head 52 is formed by crimping the protruding end portion.

Load of stress, which is to be applied to the axial end surfaces of the annular components 4A, 4B by the rivet head 51 and crimping rivet head 52 of the rivet 5, is dispersed by washers 6. Therefore, contact parts of the annular components 4A, 4B with the rivet head 51 and the crimping rivet head 52 are suppressed from being damaged due to the stress. Incidentally, in an apparatus (for example, a pump for liquefied gas) to which the deep groove ball bearing 10 is to be attached, when it is intended to make an axial length of the deep groove ball bearing 10 as small as possible because a surrounding space of the deep groove ball bearing 10 is small, spot facing holes may be provided at the openings of the through-holes 42a, 42b so as to prevent the rivet head 51 and the crimping rivet head 52 from protruding axially outwards from sides of the deep groove ball bearing 10. When the rivet head 51, the crimping rivet head 52 and the washers 6 are accommodated in the spot facing holes, the rivet head 51 and the crimping rivet head 52 do not protrude axially outwards from sides of the deep groove ball bearing 10, so that it is possible to reduce the axial length of the deep groove ball bearing 10.

Further, the rivet 5 is inserted into the spring pin 7, so that it is possible to suppress the rivet 5 from being bent due to a force, which is to be applied when crimping the end portion of the rivet 5. Also, the rivet 5 may be deformed due to contraction of the cage 4 in the low temperatures. However, the spring pin 7 is used, so that the deformation of the rivet 5 is suppressed by the spring pin 7 because an amount of contraction of the spring pin 7 is less than an amount of contraction of the cage 4.

The spring pin is a hollow tube formed by rolling up an elastic plate into a cylindrical shape and is a member having a slit provided at one place on a circumference thereof and extending in a longitudinal direction and having a C-shaped section (a section taken along a plane orthogonal to the longitudinal direction). An outer diameter of the spring pin is greater than an inner diameter of the linear hole, and a length thereof is the same as a length of the linear hole.

The materials of the rivet 5, the washer 6 and the spring pin 7 are not particularly limited. However, stainless steel (for example, austenitic stainless steel, martensitic stainless steel), carbon steel, copper or aluminum is preferable.

In the present invention, the inner ring 1 and the outer ring 2 are formed of any one steel material of bearing steel (for example, a coefficient of linear expansion of SUJ2 is 12 to 12.5×10⁻⁶/° C.), stainless steel (a coefficient of linear expansion: 10 to 11 ×10⁻⁶/° C.), high-speed tool steel (a coefficient of linear expansion: 10 to 12×10⁻⁶/° C.), and cemented steel (a coefficient of linear expansion: 11 to 12×10⁻⁶/° C.).

Any known steel material can be used. However, as the bearing steel, high-carbon chrome bearing steels SUJ2, SUJ3, SUJ4, SUJ5 defined by Japanese Industrial Standards of Japanese Industrial Standards Committee are preferable.

As the stainless steel, martensitic stainless steel, ferritic stainless steel, austenitic stainless steel and precipitation hardening stainless steel defined by Japanese Industrial Standards of Japanese Industrial Standards Committee are preferable. Also, as the martensitic stainless steel, SUS403, SUS420 and SUS440C are more preferable, as the ferritic stainless steel, SUS430 is more preferable, as the austenitic stainless steel, SUS303, SUS304, SUS305, SUS316 and SUS317 are more preferable, and as the precipitation hardening stainless steel, SUS630 or SUS631 is more preferable.

As the high-speed tool steel, high-speed tool steel M50 defined by AISI Standards of American Iron and Steel Institute or high-speed tool steel SKH4 defined by Japanese Industrial Standards of Japanese Industrial Standards Committee is preferable.

As the cemented steel, SCr420, SCM420 and SNCM420 defined by Japanese Industrial Standards of Japanese Industrial Standards Committee are preferable.

The steel material is preferably subject to sub-zero treatment in advance. By the sub-zero treatment, it is possible to minimize a change in size in use. In the meantime, the sub-zero treatment may be the same as the conventional art.

The ball 3 is formed of ceramic having a coefficient of linear expansion of 70% to 105% of the coefficient of linear expansion of the steel material forming the inner ring and the outer ring. Hereinafter, a ratio of (the coefficient of linear expansion of the ceramic forming the ball/the coefficient of linear expansion of the steel material forming the inner ring and the outer ring) is referred to as ‘linear expansion coefficient ratio.’ The linear expansion coefficient ratio is set to 70 to 105% and the change in size due to the thermal expansions of the ceramic and steel material is suppressed, so that it is possible to reduce an amount of change in a bearing internal clearance depending on temperatures. In particular, regarding a utility where the bearing is exposed to a liquefied gas having a low boiling point such as liquid nitrogen, the excellent wear resistance improvement effect is accomplished. When the linear expansion coefficient ratio is less than 70% or greater than 105%, the sufficient improvement effect is not accomplished. The linear expansion coefficient ratio is preferably 80 to 100%.

The ceramic is not particularly limited inasmuch as the linear expansion coefficient ratio is satisfied. However, metal-oxide ceramic is preferable because it is inexpensive. Above all, zirconia-based ceramic is preferable, and alumina and zirconia, and alumina and stabilized zirconia are particularly preferable. For example, zirconia-alumina is preferable in which a mass ratio between the alumina component:the zirconia component or stabilized zirconia component=5:95 to 50:50. In the meantime, the stabilized zirconia component contains a stabilizer such as yttria, calcia, magnesia, ceria and the like. Zirconia-yttria based zirconia is also preferable which includes tetragonal zirconia and monoclinic zirconia and in which a mole ratio of (yttria/zirconia) is 2.0/98.0 to 4.0/96.0 and the alumina is contained in an amount of 0.01 to 5.0 mass %.

In particular, the ratio of alumina component:zirconia component is more preferably 10:90 to 30:70, most preferably 20:80.

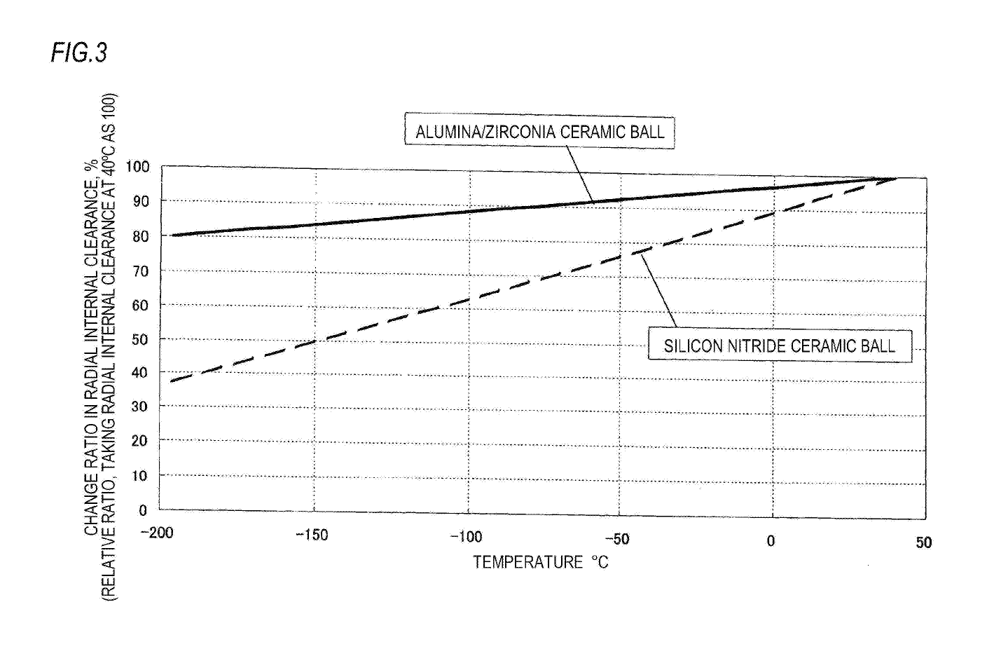

FIG. 3 is a graph showing a calculation result of a radial internal clearance depending on temperatures for a rolling bearing having inner/outer rings made of SUS440C and a ball made of silicon nitride or a ball made of alumina-zirconia. The coefficient of linear expansion of SUS440C was 10.1×10⁻⁶/° C., the coefficient of linear expansion of silicon nitride was 2.8×10⁻⁶/° C. (the linear expansion coefficient ratio: 27.7%), and the coefficient of linear expansion of alumina-zirconia was 9.0×10⁻⁶/° C. (the linear expansion coefficient ratio: 90%). As a result, in the case of the ball made of alumina-zirconia, an amount of the change in the radial internal clearance was suppressed to 20% even in the extremely low temperature of −196° C. However, in the case of the ball made of silicon nitride, an amount of the change in the radial internal clearance exceeded 20% at about −40° C. and exceeded 60% at −196° C.

The alumina sintered particles are compressed and the zirconia sintered particles are applied with tensile stress due to a difference of volume contractions upon cooling from sintering to room temperatures, and a crack comes to progress taking a detour due to a difference of distributions of the residual stress. The crack comes to progress along the alumina sintered particles having weak strength. At this time, the compressive stress is applied to the alumina particles by phase transition (tetragonal->monoclinic) of the zirconia sintered particles, so that the crack progressing is prevented.

For this reason, when the amount of the zirconia component is less than 70 mass %, it is difficult to exhibit the effect of applying the compressive stress to the alumina particles by the phase transition, so that the strength is lowered. When the amount of the zirconia component exceeds 90 mass %, the particle growth/agglomeration is likely to occur and the strength is lowered due to the abnormally grown zirconia sintered particles.

In order to manufacture the ball 3, respective raw material powders (alumina raw material powders and zirconia raw material powders) may be mixed, the mixture may be formed into a spherical shape, and the formed produce may be degreased, sintered and HIP-treated. At this time, for further densification, the impurities included in the respective raw material powders are preferable as small as possible, and particularly, SiO₂, Fe₂O₃ and Na₂O are reduced as much as possible to improve the sinterability, which is efficient for the densification. Further, it is possible to suppress the early peeling due to the impurities. Specifically, contents of SiO₂, Fe₂O₃ and Na₂O are preferably 0.3 mass % or less, respectively, more preferably 0.1 mass % or less, and most preferably 0.02 mass % or less. When the content exceeds 0.3 mass %, the particles are likely to be detached from a surface of the rolling element during an operation, so that the surface roughness of the rolling element is lowered, an orbital surface is slightly damaged due to the detached particles and the vibrations increase, thereby shortening the acoustic lifetime. Also, the fatigue lifetime of the rolling element may cause the early peeling due to the impurities.

The compression formation is generally used as the forming method. After the sintering, the material (material ball) is ground and polished, so that it is adjusted into a predetermined spherical shape. The HIP treatment may be performed in accordance with the normal conditions.

When the raw material powders are not uniformly mixed and the respective sintered particles are segregated, the rolling fatigue lifetime is lowered. In particular, this phenomenon becomes prominent when the sintered particles greater than 100 μm exist. In order to prevent the segregation, it is necessary to perform not only the uniform mixing but also the mixing having a function of strongly pulverizing the particles. Regarding this, a ball mill mixer can be used. However, a bead mill mixer in which zirconia-based beads of φ1 mm or less are used as a pulverization medium is most effective.

In the ball 3, the alumina sintered particles, and the zirconia sintered particles or the stabilized zirconia sintered particles preferably have an average particle size of 2 μm or less, more preferably 1 μm or less. In general, when the particles are sintered, the particles grow to some extent. As disclosed in JP-B-3910310, when the particles of 10 μm or greater exist, it badly influences the lifetime. However, when the particles are made into a composite, the particle growth/agglomeration is suppressed, so that the particle size becomes smaller than that of a unitary body.

It is preferable that the number of the zirconia agglomerates or the stabilized zirconia agglomerates is few on the surface of the ball 3. The zirconia agglomerates or yttria-zirconia agglomerates of 10 to 30 μm are preferably 5/300 mm² or less, and more preferably 3/300 mm² or less. The peeling occurs due to the zirconia agglomerates or the stabilized zirconia agglomerates, thereby lowering the rolling lifetime. In particular, when the agglomerates of about 100 μm exist, the rolling lifetime is prominently lowered. In the meantime, since a section of the agglomerate is not circular, a size of the agglomerate is defined as a length of a part having a longer diameter.

The ceramic is made to have the hardness of Hv 1000 to Hv 1500, so that it is possible to further decrease the wear. More preferably, the hardness is Hv 1100 to Hv 1400. In order to configure the corresponding hardness, the particle size of the sintered particles and the sintering conditions may be adjusted.

The cage 4 is preferably a plastic cage made by molding a resin composition for wear reduction, and more preferably contains a solid lubricant for providing a lubricating property and a fibrous filler for reinforcement. As the resin component, PTFE, PFA, ETFE, PVDF, FEP, PCTFE, ECTFE, PEEK, PPS, polyamide, polyimide and the like may be used which have been used as the cage material. However, PTFE, polyamide, PEEK and PPS are preferable. The resin components may be independently used or a plurality of types thereof may be mixed. The resin component is a main component of the plastic material, and is preferably included in an amount of 50 mass % or more of the total material.

As the solid lubricant, graphite, hexagonal boron nitride, mica, melamine cyanurate, graphite fluoride, MoS₂, WS₂ and the like may be used which have been used in the conventional art. However, graphite, MoS₂ and WS₂ are preferable. The solid lubricants may be independently used or a plurality of types thereof may be mixed. The cage 4 contains the solid lubricant, so that it is possible to provide the lubricating property without using the lubricant oil or grease. A pump for liquefied gas may be used in a non-lubrication environment where the lubricant oil or grease is not used, so that it is possible to improve the wear resistance by the solid lubricant.

As the fibrous filler, aluminum borate whisker, potassium titanate whisker, carbon whisker, graphite whisker, carbon fiber, glass fiber, silicon carbide whisker, silicon nitride whisker, alumina whisker and the like may be used which have been used in the conventional art. However, the glass fiber, the carbon fiber, the calcium titanate whisker and the aluminum borate whisker are preferable. The fibrous fillers may be independently used or a plurality of types thereof may be mixed. The fibrous filler may be treated by a silane-based coupling agent, a titanate-based coupling agent and the like so as to increase the adhesiveness to the resin component. The fibrous filler is contained, so that the size stability increases.

The resin composition may further contain a heat stabilizer such as iodide compound, an antioxidant such as amine compound and phenol compound, and a light stabilizer, as required, so as to prevent deterioration due to heat and light.

In the resin composition, it is preferable that the resin component is 50 to 90 mass %, the fibrous filler is 10 to 30 mass %, and the solid lubricant is 0 to 20 mass %. When the other additives such as heat stabilizer are added, the additives are preferably contained in an amount of 0 to 10 mass %, instead of some of the resin component, the fibrous filler and the solid lubricant.

The preferable resin composition is a resin composition in which the glass fiber is contained in an amount of 10 to 20 mass %, MoS₂ is contained in an amount of 4.5 to 5.5 mass % and a remnant is PTFE. In the meantime, the content of PTFE is preferably 75 to 85 mass % of a total amount of the resin composition.

The glass fiber preferably has an average fiber diameter of 1 to 10 μm and an average fiber length of 10 to 100 μm in terms of strength and dispersibility. Also, the glass fiber is preferably surface-treated by a coupling agent so as to increase the adhesiveness to PTFE, which is a matrix. Although the coupling agent is not particularly limited, a silane-based coupling agent, a titanate-based coupling agent and the like are favorably used.

When the content of the glass fiber is less than 10 mass %, the strength required for the cage 4 is deficient and the wear resistance is not also sufficient. Also, when the content of the glass fiber is greater than 20 mass %, the strength and the wear resistance increase but the glass fiber slides relative to an opposite material and wears the opposite material. Also, the formability upon the manufacturing of the cage 4 is lowered. As the formation method, an injection molding is preferable in terms of the productivity. However, as an amount of the glass fibers increases, a resin amount decreases relatively, so that the flowability decreases and the formability is lowered. In order to make it difficult for the problem to occur, the content of the glass fiber is preferably 13.5 to 16.5 mass %.

MoS₂ is an additive for providing the cage 4 with the lubricating property. When the content thereof is less than 4.5 mass %, the lubricating property cannot be provided. However, when the content of MoS₂ is greater than 5.5 mass %, the lubricating property is saturated and the dispersibility in the cage is lowered, so that the formability is also lowered. In order to make it difficult for the problem to occur, the content of MoS₂ is preferably 4.7 to 5.3 mass %. Also, MoS₂ preferably has an average particle diameter of 0.1 to 10 μm.

The remnant is PTFE. Since PTFE also has the lubricating property, PTFE further improves the lubricating property of the cage 4 in combination with MoS₂.

In order to manufacture the cage 4, the cage is manufactured by a general formation method using the above resin composition. The injection molding is preferably used in terms of the productivity.

In the meantime, the bearing accuracy is Normal class or higher of ISO492 standards and is not particularly required to have the higher accuracy.

The present invention can be applied to not only the above example but also an angular ball bearing as shown in FIG. 2. As shown, a ball 18 is held to roll freely between an inner ring 15 and an outer ring 16 by a cage 17, and the inner ring 15, the outer ring 16, the cage 17 and the ball 18 are respectively made of the above-described materials.

Further, the present invention can be applied to a cylindrical roller bearing and the like (not shown). Also, the present invention can be favorably applied to a bearing of which an inner diameter is 10 to 140 mm and an outer diameter is 22 to 300 mm.

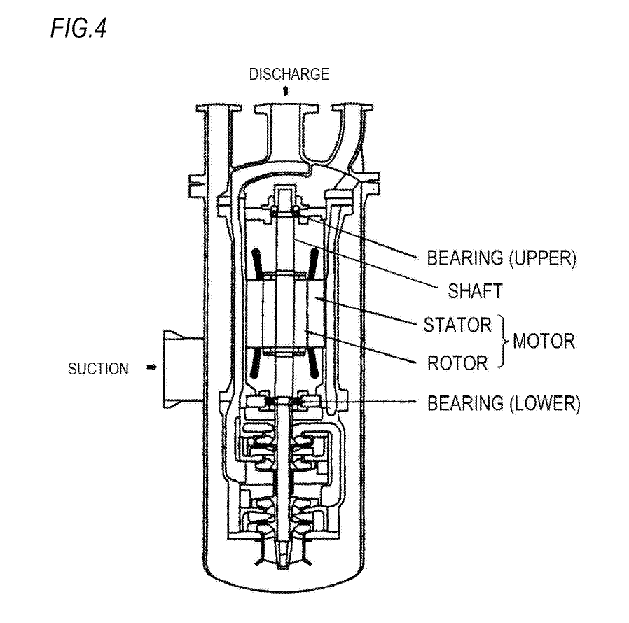

As described above, since the rolling bearing of the present invention can be used in the non-lubrication environment and has the improved durability, it is preferably used to support a main shaft of the pump for liquefied gas, particularly. As the pump for liquefied gas, a submerged pump for liquefied gas as shown in FIG. 4 may be exemplified.

The submerged pump for liquefied gas has a motor in a pump casing having a suction port and a discharge port, and is configured to discharge low-temperature liquid suctioned from the suction port from the discharge port to an outside of the pump. In the present invention, as an upper bearing and a lower bearing for supporting a shaft to be fitted to a rotor of the motor, the above rolling bearing is used.

### EXAMPLES

In the below, the present invention is further described with reference to examples and comparative examples. However, it should be noted that the present invention is not limited thereto.

### Example 1

### (Verification of Linear Expansion Coefficient Ratio)

The inner ring and the outer ring of the deep groove ball bearing having a bearing number ‘6320’ was manufactured by the steel material consisting of SUS440C (coefficient of linear expansion: 10.1×10⁻⁶/° C.) and sub-zero treated. The balls were manufactured by alumina-zirconia (coefficient of linear expansion: 9.0×10⁻⁶/° C.), silicon nitride (coefficient of linear expansion: 2.8×10⁻⁶/° C.) and SUS440C. A test bearing was manufactured together with the cage made of the synthetic resin having the glass fiber and MoS₂ added to polyamide.

The durability of the test bearing was evaluated. The test conditions are as follows. A relative value ‘1’ is set for the SUS440C product. ‘B’ indicates 1, ‘A’ indicates 2 or greater and less than 3, and ‘AA’ indicates 3 or greater. The results are shown in Table 1.

external temperature (test temperature): −196° C.

number of rotations: 5000 min⁻¹

axial load: 980N

The radial internal clearances were calculated with respect to the external temperatures of +40° C. to −196° C., and relative values were obtained taking a value at +40° C. as 100%. ‘A’ indicates that a change amount at −196° C. is 20% or less, ‘C’ indicates that the change amount is greater than 20%. The results are shown in Table 1.

TABLE 1

| | | | linear | change in | |
|---|---|---|---|---|---|
| | materials of | | expansion | radial | |
| | inner/outer | materials | coefficient | internal | dura- |
| | rings | of ball | ratio | clearance | bility |
| Comparative | SUS440C | SUS440C | 100% | A | B |
| Example 1 | | | | | |
| Comparative | SUS440C | silicon | 28% | C | A |
| Example 2 | | nitride | | | |
| Example | SUS440C | alumina- | 89% | A | AA |
| | | zirconia | | | |

From Table 1, it can be seen that when the ball made of alumina-zirconia having the linear expansion coefficient ratio of 89%, which is within the present invention, is used, it is possible to highly improve the durability because the wear is less generated while the equivalent radial internal clearance is maintained, as compared to the comparative example 2 where the ball is made of the same material as the inner/outer rings.

### Example 2

In the below, a test method of verifying the respective contents of the glass fiber and MoS₂ of the resin composition forming the cage and a result thereof are described. First, a test apparatus is described.

(1) Slide Friction/Wear Test Apparatus

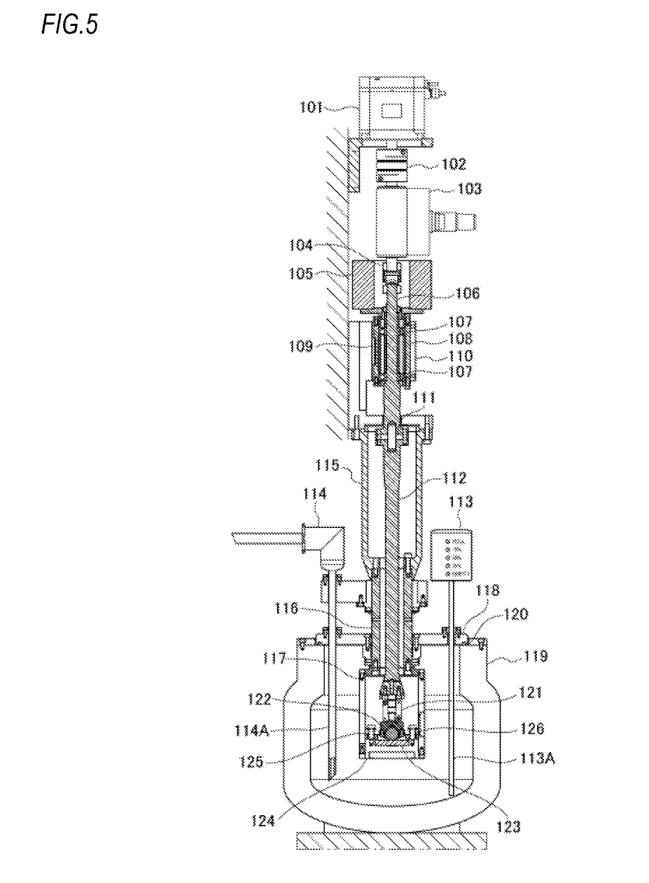

As shown in FIG. 5, according to the test apparatus, a driving shaft 106 is connected via a linear motion joint 104 (which transmits a rotating force but does not transmit an axial force by a mechanism configured to axially slide). The driving shaft 106 is supported to a support bearing 107, and the support bearing 107 is supported to a support bearing cylinder 108. The support bearing cylinder 108 has a cylindrical shape and is supported to a support bearing housing 110 by loose fit so that it can be freely linearly moved. The support bearing cylinder 108 is not rotated around the driving shaft by a key 109. A weight 105 is arranged at an end portion of the support bearing cylinder 108 facing a motor. By adjusting a weight of the weight 105, it is possible to set thrust load of a sample counter shaft, which is to be applied to a sample 123 (which will be described later), to a predetermined magnitude. A side of the driving shaft 106 opposite to the motor is provided with an end surface, which is connected to an end surface of a rotating shaft 112 via an adiabatic connecting plate 111. Since the adiabatic connecting plate 111 is made of ceramic (SiO₂/Al₂O₃, ZrO₂ and the like) having a low thermal conductivity, the heat from the rotating shaft 112 is difficult to be transferred to the driving shaft 106. Since a tip of the rotating shaft 112 opposite to the motor is cooled by liquid nitrogen, the rotating shaft is made to have a large axial length, so that the heat is not transferred to the driving shaft 106 as much as possible (i.e., the driving shaft is not cooled). A sample housing 117 is connected to the support bearing housing 108 via a first casing 115 and a second casing 116 coaxially connected. From an end surface of the sample housing 117 opposite to the motor, a sample stand 124 is inserted and connected and the sample 123 having a disc shape is loaded on a central recess portion of the sample stand 124. The sample 123 is in contact with a sample presser 125 at an opposite surface to the sample end surface fitted in the recess portion of the sample stand 124, and is pressed and supported to a bottom of the recess portion of the sample stand 124 by a force of a spring 126 arranged in the vicinity of the outer periphery of the sample. The spring 126 is made of SUS304 by which a spring constant is little influenced even in the low temperature of the liquid nitrogen. A ball 127 held by a ball holder 122 is in contact with the end surface of the sample 123, which is opposite to the end surface fitted in the sample stand 124. A solid shaft coaxial with a ball holder taper part 129 is provided on an end surface of the ball holder 122 opposite to the sample 123 and is coaxially connected to the rotating shaft 112 via a rigid coupling 121 (a non-deformable coupling having no elastic structure).

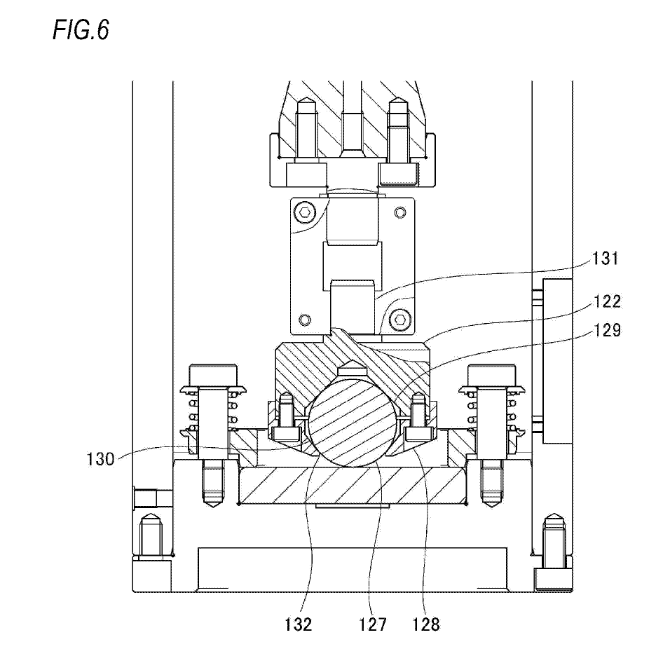

FIG. 6 is an enlarged view showing a vicinity of the ball 127. An end surface of the ball holder 122 facing the sample 123 is provided with the ball holder taper part 129, and the ball 127 is accommodated therein. The ball 127 is pressed from the sample-side towards the ball holder taper part 129 by a ball presser 128. An end surface of the ball presser 128 facing the ball is provided with a ball presser taper part 130. Therefore, when the ball presser 128 and the ball holder 122 are fastened by a screw, the ball 127 is pressed to the ball holder taper part 129. An end surface of the ball presser 128 facing the sample is provided with an opening 132. From the opening, a part of the ball 127 protrudes towards the sample beyond the end surface position of the ball presser 128, so that the sample end surface and the ball surface can be contacted to each other. As described above, the taper of the ball holder taper part 129 is formed coaxially with a shaft part 131 for ball holder coupling provided at the opposite side of the sample 123, so that the ball 127 can be rotated coaxially and integrally with the rotating shaft 112 via the rigid coupling 121.

Regarding the thrust load, since the driving shaft 106, the support bearing cylinder 108, the support bearing 107 and the like, the adiabatic connecting plate 111 and the like, the rotating shaft 112, the rigid coupling 121, the ball holder 122, and the ball 127 are integrated, a summed load of the own weights of the members and the weight of the weight 105 is applied to the end surface of the sample 123, as the thrust load. When the motor 101 is rotated with predetermined thrust load being applied, the end surface of the sample 123 and the ball 127 relatively rotate and slide, so that a slide friction/wear test can be performed. Even when the vicinity of the sample 123 is cooled by the liquid nitrogen and the members are thermally contracted and axially shrunken, the linear motion joint 104 functions to absorb the contraction. Therefore, the thrust load is stably applied to the sample 123 without being changed.

A test is performed by inserting the sample housing 117 from an opening 120 of a Dewar receptacle 119, sealing the same with a top plate 118 made of a synthetic resin, and injecting into the Dewar receptacle 119 the liquid nitrogen by a liquid nitrogen supply nozzle 114 inserted into the top plate 118 from an outside to a level at which the sample counter shaft is dipped. Thereby, it is possible to establish the slide friction/wear test in the liquid nitrogen. A liquid surface level of the liquid nitrogen in the Dewar receptacle is monitored by a liquid nitrogen level sensor 113. When the liquid surface drops below a predetermined position (a predetermined position of five levels arranged on a sensor tip 113A) due to evaporation of the liquid nitrogen, for example, an automatic liquid nitrogen supply apparatus (not shown) operates to replenish the liquid nitrogen from a tip 114A of the liquid nitrogen supply nozzle 114. Thereby, the test continues with the test counter shaft (specifically, the contact surface between the test counter shaft and the sample 123) being dipped in the liquid nitrogen.

During rotation of the sample counter shaft, dynamic friction torque can be measured by a torque meter 103. Although the measured values include the dynamic friction torque of the support bearing 107, too, it is assumed that the dynamic friction torque value of the support bearing 107 is value and a remaining value obtained by excluding the same from the measured values is a dynamic friction torque value of the friction/wear test.

Then, after the ball 127 is rotated by a predetermined total number of rotations, the sample 123 is taken out, and a weight value thereof after the test is measured and is subtracted from the weight value before the test, so that an wear weight of the sample 123 can be obtained.

(2) Bearing Test Apparatus

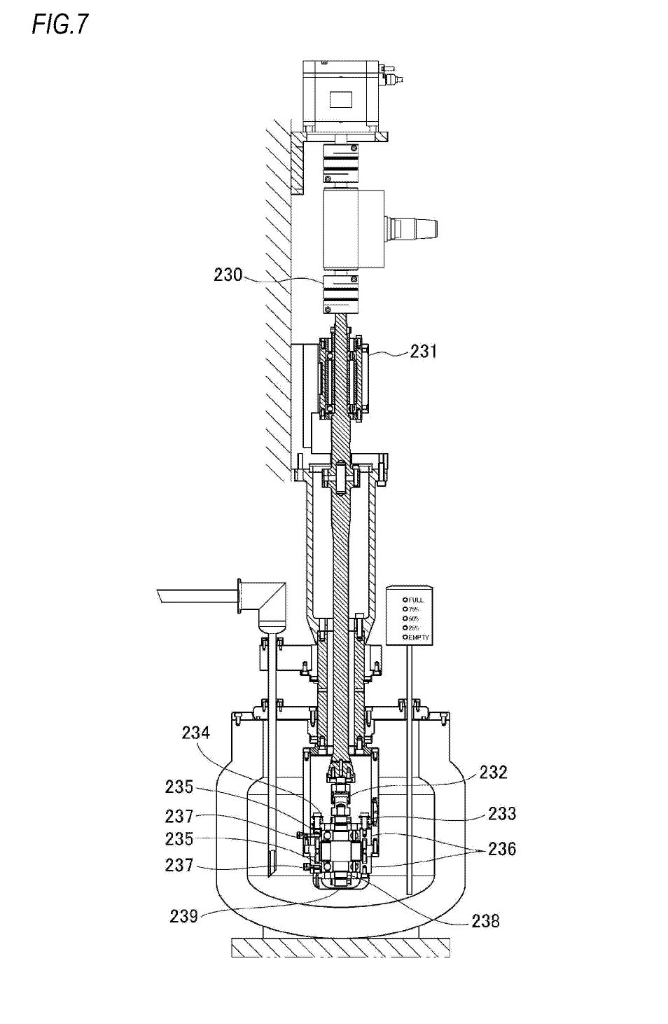

The bearing test apparatus is configured by replacing the surrounding members of the sample housing 117 from the slide friction/wear test apparatus and most of the remaining members are common. Therefore, only a difference is described. As shown in FIG. 7, the torque meter and the driving shaft are connected by a usual coupling 230, not the linear motion joint. The support bearing cylinder is fitted to the support bearing housing, which is the same as the test apparatus shown in FIG. 6. However, a set screw 231 is arranged, so that the support bearing cylinder and the support bearing housing are fixed without moving relative to each other.

Upper and lower test bearings 235 are the same type, are fitted to both ends of a test bearing shaft 238, are loaded to a test bearing housing 236, are applied with preload of a spring 233 via a bearing presser 234 and are thus supported by a spindle structure under preload. The test bearing housing 236 is loaded and fastened from an opening of the sample housing opposite to the motor.

An end portion of the test bearing shaft 238 facing the motor is connected to the rotating shaft by a linear motion joint 232. Even when the test bearing shaft 238 and the sample housing are relatively axially displaced due to a cooling influence of the dipping in the liquid nitrogen, the axial displacement is absorbed by the function of the linear motion joint 232, so that the axial load (except for the preload) is not applied to the test bearing 235. The spring 233 for preload is made of SUS304 by which a spring constant is little influenced by the cooling influence of the liquid nitrogen.

An end cap 239 is arranged in the vicinity of the lower test bearing 235. Since a large opening is formed at a center of the end cap 239, the liquid nitrogen can be freely introduced through the opening. After the sample housing having the test bearings 235 mounted thereto is inserted into the Dewar receptacle and is fixed at a predetermined position, the liquid nitrogen is injected to a level above the upper test bearing 235. Then, when the motor is rotated, it is possible to perform the bearing rotating test in the liquid nitrogen. During the rotation, a change in the dynamic friction torque of the test bearing 235 is monitored by the torque meter. In addition, when a rapid temperature change of the test bearing 235 occurs, it can be detected by a thermocouple 237 arranged in contact with the outer ring of the test bearing 235.

When the liquid surface level of the liquid nitrogen drops, the liquid nitrogen is replenished through the supply nozzle by operations of the liquid nitrogen liquid surface sensor and the automatic liquid nitrogen supply apparatus (not shown). Thereby, the state where the sample housing (test bearings 235) is dipped in the liquid nitrogen is kept, which is the same as the test apparatus shown in FIG. 6.

(3) Rivet-Fastened Ability Evaluation Test Apparatus

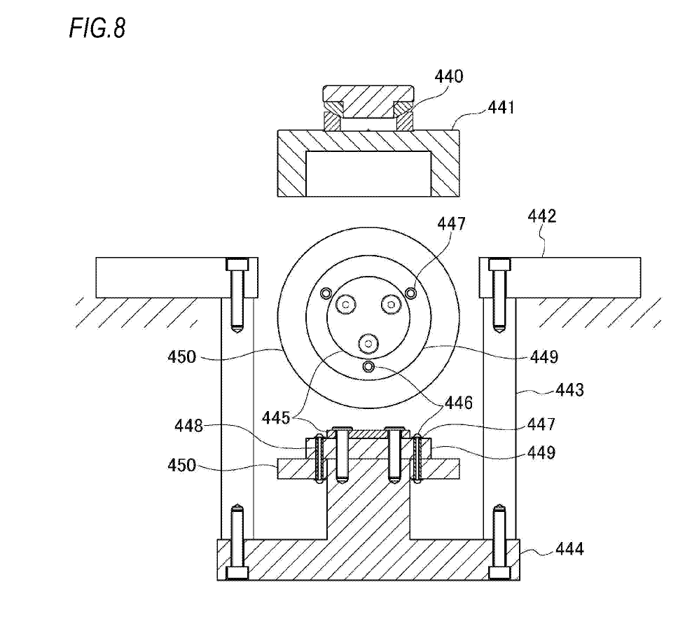

As shown in FIG. 8, the test apparatus has a configuration where a plurality of struts 443 is arranged to be perpendicular to an end surface of a support ring 442 from a vicinity of an opening mouth of the support ring 442 and opposite sides of the struts 443 to a support ring end surface are positioned at the lower. A two-step cylinder-shaped sample stand 444 is fastened to the opposite sides of the struts 443 to the support ring end surface. Looking down from the above of the support ring opening, it can be seen that an end surface of the sample stand 444 is arranged below a central position of the support ring opening.

Two samples are provided. That is, a small diameter sample 449 has a disc shape, and a large diameter sample 450 has a ring shape. Both samples 449, 450 are coaxially overlapped, through-holes are formed at trisection positions of the overlapping part, spring pins 448 are inserted therein, and rivets 446 are inserted into inner diameter holes of the spring pin 448s or directly inserted into the through-holes and crimped from both sides to form rivet heads, so that both samples 449, 450 are fastened. Depending on the test conditions, washers 447 are inserted between the rivet heads and the samples 449, 450. In the meantime, the fastening may also be made by the rivets 446 without inserting the washers 447 and the spring pins 448 or only by the rivets 446 and the washers 447.

In the meantime, the small diameter sample 449 has about φ40 mm×5 mm, the large diameter sample 450 has about φ55 to 60 mm×φ30 mm×5 mm, the rivet 446, the washer 447 and the spring pin 448 are all made of SUS304, the rivet 446 has a shape of which a central straight part has a diameter of φ1 mm and the rivet head has a diameter of φ2 mm, the washer 447 has a shape of which an outer diameter is φ3 mm and an inner diameter is φ1 mm, and the spring pin 448 has a shape of which an outer diameter is φ2 mm to 2.25 mm.

The two samples were manufactured. That is, one sample was manufactured by fastening both samples 449, 450 divided in two only with the rivets 446. The other sample was manufactured by inserting and integrating the spring pins 448 and inserting the rivets 446 having the washers 447 mounted thereto into the spring pins 448 to fasten both samples divided in two. Also, the pure PTFE sample having the same shape was manufactured by the same manner.

The inner diameter of the large diameter sample 450 is set so that the end surface part of the sample stand 444 is fitted thereto. When both fastened samples 449, 450 are fitted, the end surface of the small diameter sample 449 is contacted to the end surface of the sample stand. When the screws are inserted into the through-holes formed at the trisection positions of the small diameter sample 449 and the small diameter sample 449 and the sample stand 444 are thus fastened, the sample can be fixed to the sample stand 444. At this time, a pressing plate 445 is inserted between screw heads and the end surface of the small diameter sample 449 and is configured as a back plate of the small diameter sample 449 so that the fastening force is uniformly applied to an area of the small diameter sample 449 corresponding to the pressing plate without being concentrated on parts of the small diameter sample 449 corresponding to the screw heads.

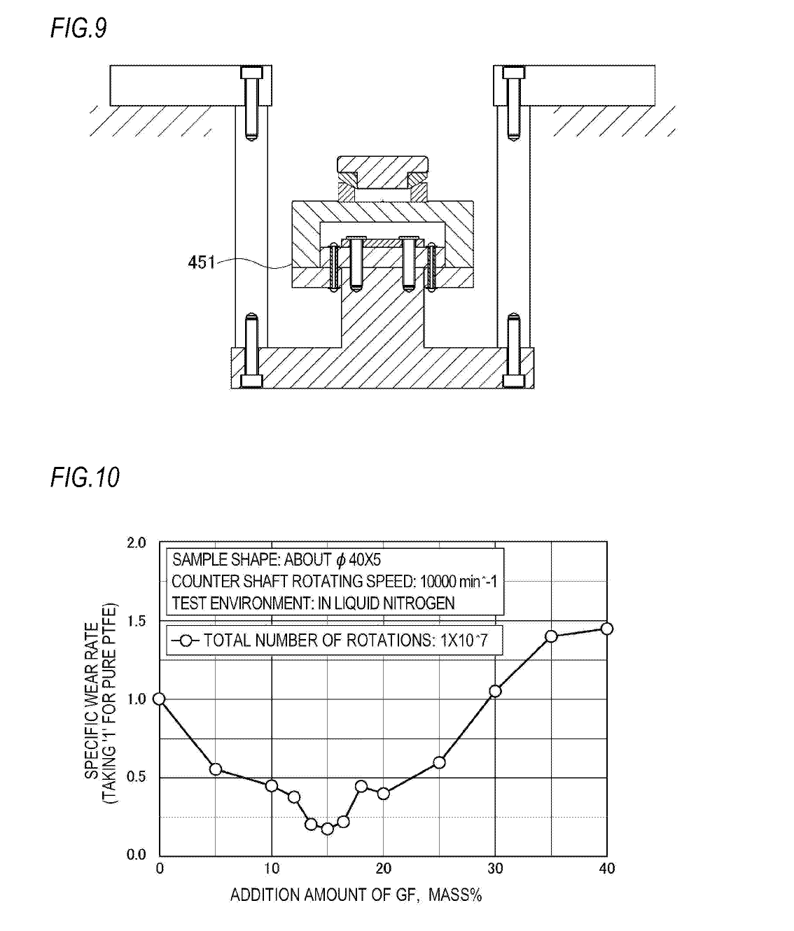

An inner diameter of a pressing die 441 is set so that the outer diameter of the small diameter sample 449 is fitted therein. When the pressing die 441 is fitted to the small diameter sample 449, a pressing die end surface 451 is contacted to an area (a ring-shaped part close to the outer periphery) of the end surface of the large diameter sample 450, which does not overlap with the small diameter sample 449, as shown in FIG. 9. At this time, when the pressing die 441 is depressed from above via a spherical surface seat 440, the pressing die end surface 451 depresses the ring-shaped part close to the outer periphery of the large diameter sample 450. Since the small diameter sample 449 is fixed to the end surface of the sample stand 444, even when the pressing die 441 descends to depress the large diameter sample 450 and the large diameter sample 450 is thus displaced downwards, the small diameter sample 449 continues to stay at an original position. Therefore, both samples 449, 450 are applied with the load of separating the same from each other.

When the depressing load is gradually increased, the samples 449, 450 or the rivets 446 cannot bear the load, so that the samples 449, 450, the rivets 446 or both of them are fractured and both samples 449, 450 are separated. When the depressing load is stopped before the fracture, the rivets 446 are bitten in the thicknesses of the samples. By measuring the biting depth of the rivet 446 or the biting depth of the washer 447, it is possible to quantitatively evaluate the rivet fastening ability of the samples 449, 450. In the meantime, the biting places are six places in total on the surface and backside of the samples. Therefore, an average value of the biting depths at the six places is set as ‘biting depth.’

An outer diameter of the support ring 442 is set to be greater than an opening diameter of the Dewar receptacle (not shown). A lower part than the support ring 442 is inserted into the Dewar receptacle, the support ring 442 is supported at the opening mouth of the Dewar receptacle, and the liquid nitrogen is injected to a position above the sample position from the liquid nitrogen supply apparatus (not shown) and the liquid nitrogen supply nozzle thereof to dip the samples 449, 450 therein. Thereby, it is possible to perform the comparison evaluation of the rivet fastening ability of the sample material in the liquid nitrogen.

With the above test apparatuses, following verification was performed.

(Verification of Glass Fiber Content)

Here, a relation between the content of the glass fiber and the wear amount in the liquid nitrogen was examined for the cage containing only the glass fiber without MoS₂.

First, the glass fibers (diameter: 1 to 10 μm, length: 10 to 100 μm) were added and mixed with PTFE powders in the amount of 0 to 40 mass %. The mixture was melted and extruded into a string shape, which was then cut to manufacture pellets. The pellets were again melted, compressed and extruded to manufacture a round bar, which was then machined into a predetermined sample shape (about φ40 mm×5 mm). In the meantime, the surface roughness (test end surface) of the sample was made to be more favorable than 3.2 μRa.

The sample was mounted to the slide friction/wear test apparatus of FIG. 5 (the ball was made of alumina-zirconia-based composite ceramic consisting of the alumina component and the zirconia component (=20:80) and the ball surface roughness was 0.05 μmRa), and was rotated at 10000 min⁻¹ with being cooled by the liquid nitrogen (about −196° C.) up to the total number of rotations of 1×10⁷ at which it was thought to sufficiently avoid the initial wear and then the test was over. Then, the sample was taken out to measure a change in weight (weight decrease) before and after the test. The test was performed for the pure PTFE (the glass fiber was not added) by the same manner. Then, a ratio (specific wear rate) to the weight decrease of the pure PTFE was obtained.

The results are shown in FIG. 10. When an addition amount of the glass fiber is 10 to 20 mass %, the specific wear rate is prominently small and is minimized at the addition amount of 13.5 to 16.5 mass %, particularly. In contrast, when the addition amount of the glass fiber exceeds 20 mass %, the specific wear rate increases. The reason is presumed as follows: when the ball and the sample slide, the glass fibers wear the ball and the wear powders further promote the wear of the sample.

(Verification 1 of MoS₂ Content)

Here, a relation between the content of MoS₂ and the dynamic friction torque in the liquid nitrogen was examined for the cage containing only MoS₂ without the glass fiber.

First, a predetermined amount of the MoS₂ powders (particle diameter: 0.1 to 10 μm) were added and mixed with PTFE powders. The mixture was melted and extruded into a string shape, which was then cut to manufacture pellets. The pellets were again melted, compressed and extruded to manufacture a round bar, which was then machined into a predetermined sample shape (about φ40 mm×5 mm). In the meantime, the surface roughness (test end surface) of the sample was made to be more favorable than 3.2 μRa. Also, the same sample was manufactured using the pure PTFE powders not containing MoS₂.

The sample was mounted to the slide friction/wear test apparatus of FIG. 5 (the ball was made of alumina-zirconia-based composite ceramic consisting of the alumina component and the zirconia component (=20:80) and the ball surface roughness was 0.05 μmRa), and was rotated at 10000 min⁻¹ with being cooled by the liquid nitrogen to continuously measure the dynamic friction torque values. In the meantime, the dynamic friction torque values include the dynamic friction torque of the support bearing, too. However, the values including the dynamic friction torque of the support bearing as an amount of increase, which is common in all tests, were set as the dynamic friction torque values of the test. At this time, the dynamic friction torque values upon rotations of the total number of rotations of 1×10⁶, which was thought as the initial wear state, and the dynamic friction torque values upon the rotation of the total number of rotations of 1×10⁷ at which it was thought to sufficiently avoid the initial wear state were measured. The same test was performed for the pure PTFE to measure the dynamic friction torque values upon the rotation of the total number of rotations of 1×10⁶. Then, a ratio (specific dynamic friction torque value) to the dynamic friction torque value of the pure PTFE was obtained.

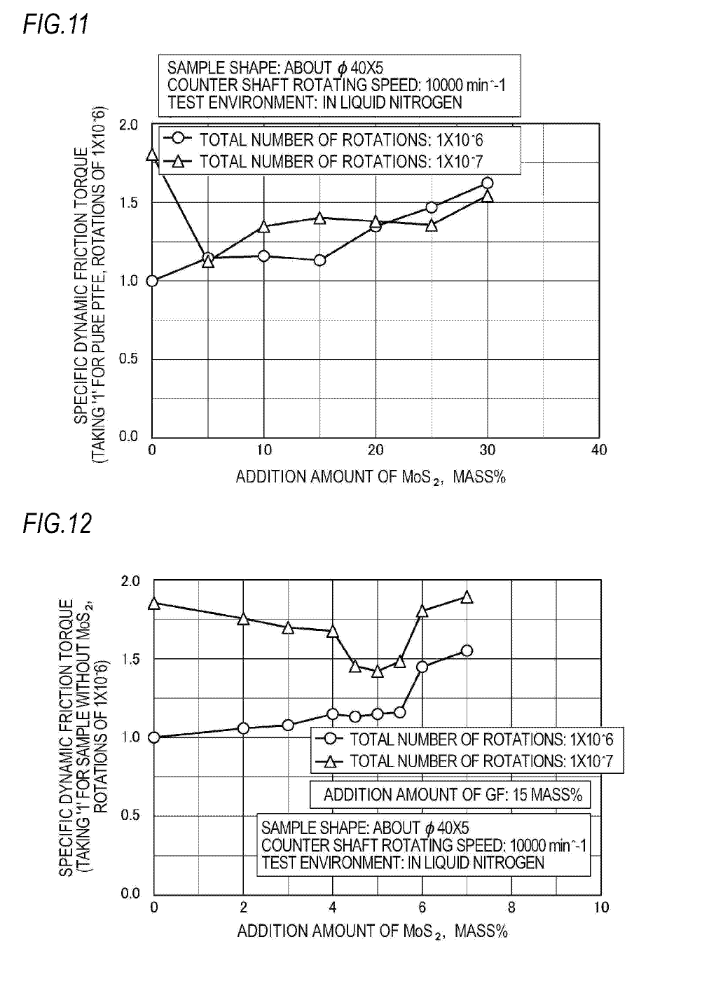

The results are shown in FIG. 11. In the case of the rotation of the total number of rotations of 1×10⁷, the specific dynamic friction torque value is smallest when the addition amount of MoS₂ is 5 mass %. Also, in the case of the rotation of the total number of rotations of 1×10⁶, the pure PTFE has the greater specific dynamic friction torque value than the sample having MoS₂ added thereto. However, when the number of rotations reaches the total number of rotations of 1×10⁷, the specific dynamic friction torque value of the sample having MoS₂ added thereto becomes less than the pure PTFE. The reason is presumed as follows: since PTFE is not worn in a form of the wear powders such as fine particles such as sugar and salt but worn in a form of agglomerates remarkably greater than the fine particles, as the wear progresses, the sample surface becomes considerably rougher, so that the dynamic friction torque value becomes greater.

(Verification 2 of MoS₂ Content)

Here, a relation between the content of MoS₂ and the dynamic friction torque in the liquid nitrogen was examined for the cage containing the glass fiber and MoS₂.

First, the glass fibers (diameter: 1 to 10 μm length: 10 to 100 μm) of 15 mass % and a predetermined amount of the MoS₂ powders (particle diameter: 0.1 to 10 μm) were added and mixed with PTFE powders. The mixture was melted and extruded into a string shape, which was then cut to manufacture pellets. The pellets were again melted, compressed and extruded to manufacture a round bar, which was then machined into a predetermined sample shape (about φ40 mm×5 mm). In the meantime, the surface roughness (test end surface) of the sample was made to be more favorable than 3.2 μRa. Also, a comparative sample containing the glass fibers of 15 mass % without MoS₂ was manufactured by the same manner.

In the same manner as the verification 1 of MoS₂ content, the dynamic friction torque value was continuously measured and the ratio (specific dynamic friction torque value) to the dynamic friction torque value of the comparative sample upon the rotation of the total number of rotations of 1×10⁶ was obtained.

The results are shown in FIG. 12. In the case of the rotations of the total number of rotations of 1×10⁷, the specific dynamic friction torque value is smallest when the addition amount of MoS₂ is 4.5 to 5.5 mass %. Also, in the case of the rotation of the total number of rotations of 1×10⁶, the comparative sample has the greater specific dynamic friction torque value than the sample having MoS₂ added thereto. However, when the number of rotations reaches the total number of rotations of 1×10⁷, the specific dynamic friction torque value of the sample having MoS₂ added thereto becomes less than the pure PTFE. The reason is presumed as follows: since PTFE is not worn in a form of the wear powders such as fine particles such as sugar and salt but worn in a form of agglomerates remarkably greater than the fine particles, as the wear progresses, the sample surface becomes considerably rougher, so that the dynamic friction torque value becomes greater.

(Comparison of Durability Performance of Rolling Bearing Having Cage

Containing Glass Fibers and MoS₂ and Rolling Bearing Having Cage Containing Glass Fibers Without MoS₂)

Based on the above results, the durability performance of the rolling bearing containing the glass fibers and MoS₂ and the rolling bearing having the cage containing the glass fibers without MoS₂ was compared.

First, the glass fibers (diameter: 1 to 10 μm, length: 10 to 100 μm) of 15 mass % and MoS₂ powders (particle diameter: 0.1˜10 μm) of 5 mass % were added and mixed with PTFE powders. The mixture was melted and extruded into a string shape, which was then cut to manufacture pellets. The pellets were again melted, compressed and extruded to manufacture a round bar, which was then machined to manufacture a machined cage (a cage containing the glass fibers and MoS₂) for an angular ball bearing (an inner diameter: 25 mm). Also, the glass fibers of 15 mass % were added to the PTFE powders without adding MoS₂ to manufacture a cage (a cage containing the glass fibers without MoS₂) by the same manner.

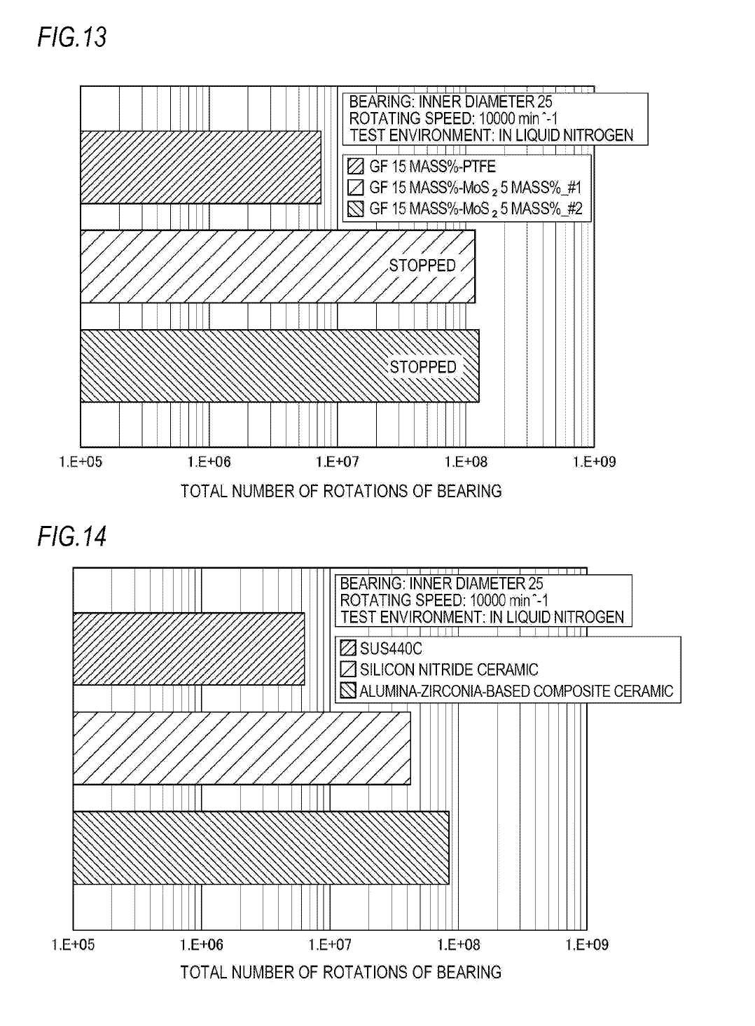

Then, an angular ball bearing was assembled using each cage, the alumina-zirconia-based composite ceramic ball (alumina component:zirconia component=20:80), and the inner and outer rings made of SUS440C heat-treated product (HrC58 or higher), and was mounted to the bearing test apparatus shown in FIG. 7. In the test apparatus, the test bearing shaft was made of SUS440C (heat-treated produce, HrC58 or higher) and the test bearing housing was made of the same material so as to make both coefficients of thermal expansion be the same. In the test, while the test bearing assembled to the spindle structure was rotated at 10000 min⁻¹ with being cooled by the liquid nitrogen, the dynamic friction torque values/the bearing outer ring temperatures were continuously measured. In the meantime, the dynamic friction torque values include the dynamic friction torque of the support bearing, too. However, the values including the dynamic friction torque of the support bearing as an offset amount, which was common in all tests, were used as the dynamic friction torque values of the test. When the dynamic friction torque value remarkably increased, the bearing outer ring temperature rapidly increased, an abnormal noise occurred or a phenomenon of which a cause was the damage of the bearing occurred, the test was stopped, the sample housing was removed from the test apparatus and the bearing was turned with a hand and observed to check whether the bearing was damaged. At this time, when it was checked that the bearing was damaged, the total number of rotations up to that time was evaluated as the durability performance of the bearing. In the meantime, the test was performed for two sets (denoted as #1, #2 in FIG. 13) of the rolling bearing having the cage containing the glass fibers and MoS₂, and for one set of the rolling bearing having the cage containing the glass fibers without MoS₂.

The results are shown in FIG. 13. In the case of the bearing having the cage containing the glass fibers without MoS₂, the durability performance test was over although the bearing did not reach the total number of rotations of 1×10⁷. In contrast, in the case of the bearing having the cage containing the glass fibers and MoS₂, the test was over after both sets exceeded the total number of rotations of 1×10⁷. That is, the bearing having the cage made of PTFE containing the glass fibers of 15 mass % and MoS₂ of 5 mass % has the durability performance of 10 times or higher in the liquid nitrogen, as compared to the bearing having the cage made of PTFE containing the glass fibers of 15 mass % without MoS₂. From this result, it can be said that the rolling bearing of the present invention is suitable as a bearing to be used in the low-temperature liquefied gas.

(Comparison of Durability Performance Depending on Ball Materials)

For the bearings to which the cage containing the glass fibers and MoS₂ was incorporated, the durability performance was compared depending on the ball materials.

First, the glass fibers (diameter: 1 to 10 μm, length: 10 to 100 μm) of 15 mass % and MoS₂ powders (particle diameter: 0.1˜10 μm) of 5 mass % were added and mixed with PTFE powders. The mixture was melted and extruded into a string shape, which was then cut to manufacture pellets. The pellets were again melted, compressed and extruded to manufacture a round bar, which was then machined to manufacture a machined cage for an angular ball bearing (an inner diameter: 25 mm).

Then, the test bearings were assembled using (1) the ball made of SUS440C (heat-treated product, HrC58 or higher), (2) the ball made of silicon nitride and (3) the ball made of alumina-zirconia-based composite ceramic (alumina component:zirconia component=20:80), the cage and the inner and outer rings made of SUS440C (heat-treated product, HrC58 or higher).

The test bearings (one set of two bearings) were mounted to the test apparatus shown in FIG. 7, and the dynamic friction torque values/the bearing outer ring temperatures were continuously measured. The dynamic friction torque values include the dynamic friction torque of the support bearing, too. However, the values including the dynamic friction torque of the support bearing as an offset amount, which was common in all tests, were used as the dynamic friction torque values of the test. When the dynamic friction torque value remarkably increased, the bearing outer ring temperature rapidly increased, an abnormal noise occurred or a phenomenon of which a cause was the damage of the bearing occurred, the test was stopped, the sample housing was removed from the test apparatus and the bearing was turned with a hand and observed to check whether the bearing was damaged. At this time, when it was checked that the bearing was damaged, the total number of rotations up to that time was evaluated as the durability performance of the bearing.

Meanwhile, in order to accelerate the evaluation test, the number of balls was reduced by 30%, as compared to the prescribed number of balls, and the load to be applied to one ball was considerably increased, as compared to the load to be applied to the prescribed number of balls. When the load to be applied to the ball increases, the frictional force to the cage increases, so that the cage is likely to be deformed or worn. Thereby, it is possible to reduce the bearing running distance (the total number of rotations), thereby accelerating the test.

The results are shown in FIG. 14. While the test was over for the test bearing using the ball made of SUS440C at the total number of rotations of 6.2×10⁶, the durability performance of the test bearing using the ball made of silicon nitride was improved to the total number of rotations of 4.2×10⁷. Also, the durability performance of the test bearing using the ball made of alumina-zirconia-based composite ceramic was further improved to the total number of rotations of 8.5×10⁷. Therefore, in the liquid nitrogen, the rolling bearing having the cage made of PTFE containing the glass fibers of 15 mass % and MoS₂ of 5 mass % has the durability performance of about 7 times when the ball was made of silicon nitride, as compared to the ball made of SUS440C, and has the durability performance of about 14 times when the ball was made of alumina-zirconia-based composite ceramic, as compared to the ball made of SUS440C. From this, it can be said that the rolling bearing having the cage containing the glass fibers and MoS₂ and the ceramic ball is suitable as a bearing to be used in the low-temperature liquefied gas. Particularly, the ball made of alumina-zirconia-based composite ceramic is more favorable.

(Rivet Fastening Ability Evaluation 1)

Here, the fastening effect obtained when the fastening was made using the rivet and the washer and the fastening effect obtained when the fastening was made using the spring pin, the rivet and the washer were evaluated.

First, the glass fibers (diameter: 1 to 10 μm, length: 10 to 100 μm) of 15 mass % and MoS₂ powders (particle diameter: 0.1˜10 μm) of 5 mass % were added and mixed with PTFE powders. The mixture was melted and extruded into a string shape, which was then cut to manufacture pellets. The pellets were again melted, compressed and extruded to manufacture a round bar, which was then machined to manufacture a small diameter sample and a large diameter sample for the river-fastened ability evaluation test apparatus shown in FIG. 8. Also, a small diameter sample and a large diameter sample made of pure PTFE were manufactured.

Then, the small diameter samples and the large diameter samples were mounted to the same test apparatus (the sample stand and the pressing die: SUS304) cooled by the liquid nitrogen by using the rivets made of SUS304, the constant load was applied in the direction of separating both fastened samples, the biting depths of the rivet heads remaining at the fastened parts were measured at six places in total and an average value thereof was obtained, so that the fastened performance of the samples was compared. Also, the same test was performed for the case where the spring pins were inserted and the washers (SUSU304) were inserted between the rivet heads and the samples. That is, the fastened performance of the samples depending on whether or not the washer was compared.

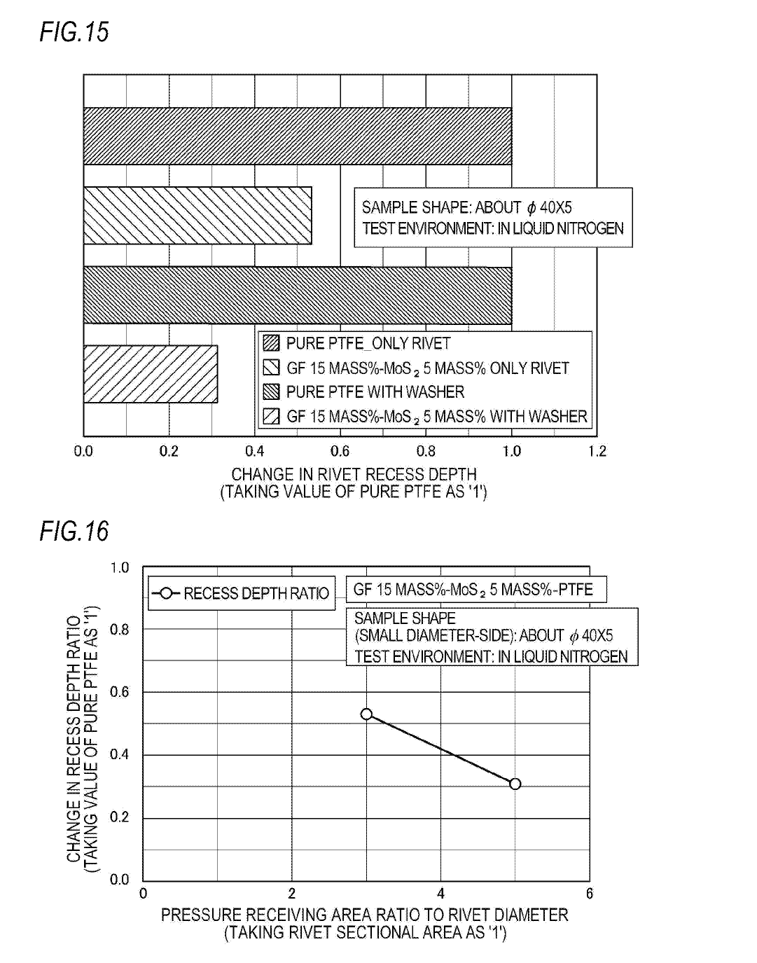

The results are shown in FIG. 15. The PTFE containing the glass fibers and MoS₂ has the rivet-fastened performance of about two times, as compared to the pure PTFE, and the rivet-fastened performance can be further increased by about three times when the washer is inserted to the rivet.

For the PTFE containing the glass fibers and MoS₂, the influences of a ratio of a rivet head area to a rivet sectional area and a washer area (ring shape) ratio were examined. In the meantime, the shape of the rivet has the central straight part diameter of φ1 mm and the rivet head diameter of φ2 mm, and the shape of the washer has the outer diameter of φ3 mm×the inner diameter of φ1 mm. As described below, a ratio of a pressure receiving area of the rivet head to the rivet sectional area is 3 and a ratio of a pressure receiving area of the washer to the rivet sectional area is 5. At this time, recess depth ratios are about 0.5 and about 0.3, respectively, as shown in FIG. 15. Therefore, it can be seen that as the pressure receiving area ratio increases, the recess depth ratio decreases. That is, when the pressure receiving area is increased by inserting the washer, the fastened performance of the PTFE containing the glass fibers and MoS₂ is further improved. In other words, it can be said that the PTFE containing the glass fibers and MoS₂ is advantageous to the washer insertion structure. FIG. 16 is a graph showing a relation between the pressure receiving area of the rivet and the rivet recess depth on the basis of the above results.

rivet sectional area: π(1²)/4

pressure receiving area of rivet head: π(2²−1²)/4

spring washer sectional area: π(2²−1²)/4

washer area: π(3²−1²)/4

pressure receiving area of washer: π(3²−2²)/4

pressure receiving area of rivet head to rivet sectional area: (2²−1²)/(1²)=3

pressure receiving area of washer to rivet sectional area: (3²−2²)/(1²)=5

(Rivet Fastening Ability Evaluation 2)

Here, the rivet-fastened performance of the cage made of PTFE containing the glass fibers and MoS₂ and the cage made of pure PTFE was compared on the basis of the results of the rivet fastening ability evaluation 1.

First, the glass fibers (diameter: 1 to 10 μm length: 10 to 100 μm) of 15 mass % and MoS₂ powders (particle diameter: 0.1 to 10 μm) of 5 mass % were added and mixed with PTFE powders. The mixture was melted and extruded into a string shape, which was then cut to manufacture pellets. The pellets were again melted, compressed and extruded to manufacture a round bar, which was then machined to manufacture a two-split-machined cage for a deep groove ball bearing (inner diameter: 25 mmm). Also, the same case made of pure PTFE was manufactured.

Then, a cage where the fastening was made only by the rivets and a cage where the fastening was made by inserting and integrating the spring pins and inserting the rivets having the washers mounted thereto into the spring pins were manufactured by using the two split cages made of the respective materials, and the deep groove ball bearings (inner diameter: 25 mm) were assembled to configure test bearings by using the cages. In the meantime, the inner and outer rings were made of SUS440C heat-treated product (HrC58 or higher), and the ball was made of alumina-zirconia-based composite ceramic (alumina component:zirconia component=20:80). At this time, the number of the rivets was limited to three so that the test bearing would be necessarily fractured at the rivet-fastened parts, and the rivets were fastened at the trisection positions on the cage circumference. The two split cages were not fastened at the other components, and formed a special cage of which the split cages were fastened only by the three rivets.

The test bearing was mounted to the bearing test apparatus shown in FIG. 7 (both the test bearing shaft and the test bearing housing were made of SUS440C heat-treated product (HrC58 or higher) so as to make both coefficients of thermal expansion be the same) and was rotated at 10000 min⁻¹ with being cooled by the liquid nitrogen, and the total number of rotations was measured until the rivet-fastened parts were damaged and the bearing could not be thus rotated. At this time, in order to accelerate the test, the preload was adjusted by the spring so that the cage would be applied by the relatively high load. Also, the test was performed four times for the same cage, respectively.

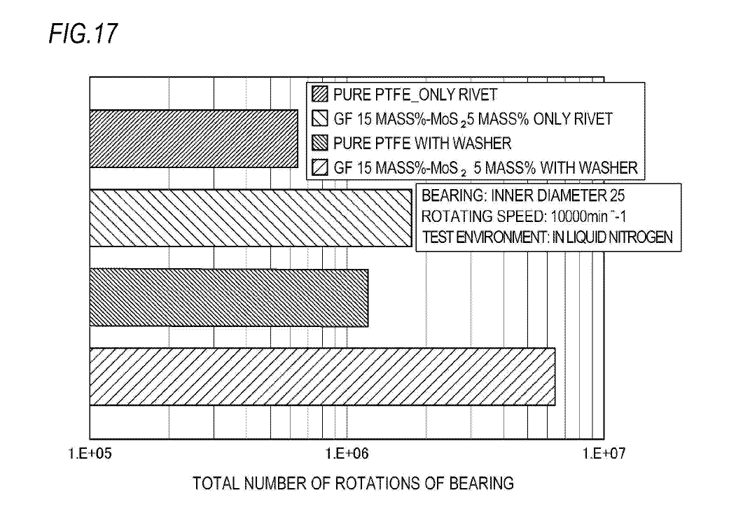

The results are shown in FIG. 17. In the liquid nitrogen, the test bearing having the cage made of PTFE containing the glass fibers and MoS₂ has the rivet-fastened performance (durability performance) of (1) three times or higher when the rivets are used without the washer and (2) five times or higher when the rivets and washers are used, as compared to the test bearing having the cage made of pure PTFE. From this, it can also be said that the PTFE resin composition containing the glass fibers and MoS₂ is suitable as the cage material of the bearing to be used in the low-temperature liquefied gas.

Although the present invention has been described in detail with reference to the specific embodiments, it is obvious to one skilled in the art that a variety of changes and modifications can be made without departing from the spirit and scope of the present invention.

The present invention is based on Japanese Patent Application No. 2013-212029 filed on Oct. 9, 2013, the contents of which is herein incorporated by reference.

### INDUSTRIAL APPLICABILITY

The present invention can be favorably used for the rolling bearing to be used for the pump for liquefied gas configured to pneumatically transport the liquefied gas in the extremely low temperature environment, for example.

### DESCRIPTION OF REFERENCE NUMERALS

1: Inner ring
2: Outer ring
3: Ball
4: Cage
5: Rivet
6: Washer
7: Spring pin

1. A rolling bearing having a plurality of rolling elements held between an inner ring and an outer ring via a cage and to be used in a liquefied gas environment or in an extremely low temperature, wherein the inner ring and the outer ring are made of steel material which is any one of bearing steel, stainless steel, high-speed tool steel and cemented steel, and wherein the rolling elements are made of ceramic having a coefficient of linear expansion of 70% to 105% of a coefficient of linear expansion of the steel material forming the inner ring and the outer ring.

2-4. (canceled)

5. The rolling bearing according to claim 1,
wherein hardness of the ceramic forming the rolling elements is Hv 1000 to Hv 1500.

6-7. (canceled)

8. The rolling bearing according to claim 1,
wherein the cage is made of a resin composition containing:
a resin component which is at least one of PTFE, 5 polyamide, PEEK and PPS;
a fibrous filler which is at least one of a glass fiber, a carbon fiber, an calcium titanate whisker and an aluminum borate whisker, and
a solid lubricant which is, at least one of graphite, MoS₂ and WS₂.

9. The rolling bearing according to claim 8,
wherein the resin composition forming the cage contains the glass fiber of 10 to 20 mass %, MoS₂ of 4.5 to 5.5 mass % and a remnant of PTFE.

10. The rolling bearing according to claim 1,
wherein the rolling element includes an alumina component and a zirconia component in a mass ratio between alumina component:zirconia component =5:95 to 50:50.

11. The rolling bearing according to claim 1,
wherein the cage is configured by split cages divided in two in a circumferential direction, and the split cages are fastened by a rivet to be integral.

12. The rolling bearing according to claim 11,
wherein a washer is inserted between a rivet head of the rivet and the split cages.

13. A pump for liquefied gas including the rolling bearing according to claim 1.

14. A cage to be incorporated into a rolling bearing which is to be used in a liquefied gas environment or in an extremely low temperature, the cage being made of a resin composition containing:
a resin which is at least one of PTFE, polyamide, PEEK and PPS,
a fibrous filler which is at least one of a glass fiber, a carbon fiber, an calcium titanate whisker and an aluminum borate whisker, and
a solid lubricant which is at least one of graphite, MoS₂ and WS₂.

15. The cage according to claim 14,
wherein the resin composition contains the glass fiber of 10 to 20 mass %, MoS₂ of 4.5 to 5.5 mass %, and a remnant of PTFE.

16. The cage according to claim 14, which is configured by split cages divided in two in a circumferential direction,
wherein the split cages are fastened by a rivet to be integral.

17. The cage according to claim 16,
wherein a washer is inserted between a rivet head of the rivet and the split cages.
